(19) United States
(12) Patent Application Publication
(10) Pub. No.: US 2025/0170507 A1
(43) Pub. Date: May 29, 2025

(54) FILTER SYSTEM FOR A FLUID, IN PARTICULAR OIL OR FUEL

(71) Applicant: MANN+HUMMEL GmbH, Ludwigsburg (DE)

(72) Inventors: Christian VOGT, Ludwigsburg (DE); Günter JOKSCHAS, Murrhardt (DE)

(21) Appl. No.: 18/957,344

(22) Filed: Nov. 22, 2024

(30) Foreign Application Priority Data
Nov. 27, 2023 (DE) 102023132951.0

(51) Int. Cl. B01D 35/30; B01D 29/15; B01D 35/00

(52) U.S. Cl. CPC B01D 35/306; B01D 29/15; B01D 35/005; B01D 2201/0415; B01D 2201/24; B01D 2201/347; B01D 2201/4092

(57) ABSTRACT

A filter system for a fluid has a cup-shaped filter housing provided with a support pipe which is aligned along a longitudinal axis of the filter housing and fixedly joined to the filter housing. A filter element is arranged around the support pipe. The support pipe is a fluid passage. The filter housing has a fluid passage at an open end thereof and is provided with a circumferentially extending seal element that seals relative to a connection flange when the filter housing is mounted as intended at the connection flange. The support pipe has a screw thread at an end facing away from the filter housing. The screw thread provides a screw connection to the connection flange. The support pipe has, arranged along a length extension of the support pipe, at least one outlet for fluid. The support pipe and the filter housing are formed together as one piece.

### CROSS-REFERENCE TO RELATED APPLICATIONS

This patent application claims the priority of the German patent application with the serial number 102023132951.0 which was filed on Nov. 27, 2023, in the German Patent and Trademark Office and whose contents is hereby incorporated by reference.

### BACKGROUND

Herein is presented an improvement for a filter system for a fluid, for example, oil, fuel, or coolant. The filter system may be for combustion engine vehicles or electrically operated vehicles. The filter system may be part of an e-axle of a hybrid or electric vehicle.

DE 197 00 564 A1 discloses a filter system, for example, for the lubricant oil of an internal combustion engine, comprised of a cup-shaped filter housing, a support pipe arranged in the filter housing, and a filter element fastened on the support pipe substantially comprised of a zigzag-folded filter material. In this context, the filter housing accommodates directly a seal for sealing between housing and flange. The support pipe is provided with a screw-on thread and fastenable by a screw connection to the flange.

DE 10 2015 114 320 A1 describes a fluid filter with a housing having a fluid inlet and a fluid drain, with a central support pipe forming the fluid drain, with a filter insert pushed onto the support pipe, and with a valve unit. At its axial end regions, the support pipe comprises a respective screw thread for connecting, on the one hand, to the housing and, on the other hand, to the filter connection flange. Furthermore, the support pipe comprises an outlet in its intermediate region. In its region located between the axial end regions, the support pipe comprises, at the outer circumference, guide elements for at least one valve body of the valve unit and/or guide and holding elements for a valve spring support of the valve unit.

### SUMMARY

An object is to provide a cost-efficient filter system for a fluid, for example, oil or fuel, which can be manufactured easily.

The aforementioned object is solved according to an aspect of the invention by a filter system for a fluid, for example, oil or fuel, at least comprising a cup-shaped filter housing with a support pipe, which is aligned along a longitudinal axis and fixedly joined to the filter housing, and a filter element arranged around the support pipe, wherein the support pipe is configured as a fluid passage, for example, a fluid outlet, wherein an open end of the filter housing comprises a fluid passage, for example, a fluid inlet, and a circumferentially extending seal element for sealing in relation to a connection flange when mounted as intended, wherein the support pipe at its free end facing away from the filter housing comprises a screw thread for a screw connection to the connection flange and, along a length extension of the support pipe, comprises at least one outlet for a filtered fluid. The support pipe and the filter housing are formed together as one piece.

Beneficial embodiments and advantages result from the additional claims, the description, and the drawing.

One embodiment is based on a filter system for a fluid, for example, oil or fuel, at least comprising a cup-shaped filter housing with a support pipe, which is aligned along a longitudinal axis and fixedly joined to the filter housing, and a filter element arranged around the support pipe, wherein the support pipe is configured as a fluid passage, for example, as a fluid outlet. An open end of the filter housing comprises a fluid passage, for example, a fluid inlet, and a circumferentially extending seal element for sealing in relation to the connection flange when mounted as intended. The support pipe comprises at its free end facing away from the filter housing a screw thread for a screw connection to the connection flange, wherein the screw thread can be incorporated in the material of the support pipe or can be carried by a separate component which is joined fixedly, for example, non-detachably, to the support pipe. Along a length extension of the support pipe, the support pipe comprises at least one outlet for fluid, for example, a filtered fluid.

According to an embodiment, the support pipe and the filter housing are formed together as one piece. In this context, the screw thread and the support pipe are not mandatorily one piece. For example, the filter housing and support pipe may be configured as a one-piece injection molded plastic part. The screw thread at the support pipe may be advantageously metallic and may be joined fixedly to the support pipe. For this purpose, the screw thread, for example, can be configured as a threaded sleeve in the form of an insertion part and can be embedded into the material of the support pipe in the injection molding process. The thread-bearing component can also be joined to the support pipe after the manufacture of the filter housing with support pipe.

The proposed filter system comprises a filter housing, configured as a filter cap, which may be advantageously formed as one piece of plastic material and provided with an axial seal.

The filter housing may comprise a central threaded rod which at the same time serves also as support pipe for the filter element and encompasses the sealing sites for the filter element. The filter system may comprise furthermore a filter element. In this manner, a spin-on filter flange can be expediently seal-tightly closed by means of the filter housing.

The support pipe may be comprised of the same material as the remainder of the filter housing and may be beneficially produced as one piece together with the filter cap. The filter housing may comprise an axial sealing principle and may be screwed like a spin-on filter to a connection flange. Advantageously, an axial shaped seal instead of an axial seal, produced by being cut from an extruded tube, can be used as a seal element in order to keep the reaction forces of the seal as small as possible.

When the filter housing is made of plastic material, it comprises beneficially a high corrosion resistance. The filter system comprises only a few parts such as filter housing, axial seal, filter element and can be mounted in a simple manner. No welding or joining processes are required. In this way, the filter system can be manufactured cost-efficiently.

According to a beneficial embodiment of the filter system, the filter element can comprise a filter medium body which is closed at end faces by end disks, wherein at least one of the end disks is configured to radially seal in relation to the support pipe. Advantageously, also both end disks can radially seal against the support pipe. In this way, a clean side of the filter system can be separated in a simple manner from the raw side.

According to a beneficial embodiment of the filter system, the at least one outlet can extend at a slant in relation to the longitudinal axis in the direction toward the open end of the filter housing. In this manner, the filter housing with support pipe can be advantageously produced and removed as one part in an injection molding process. Furthermore, outlets which are extending at a slant in relation to the longitudinal axis may have a positive effect on the flow behavior.

According to a beneficial embodiment of the filter system, the seal element can be configured to axially seal in relation to the connection flange. In this way, the filter system can be screwed expediently onto the connection flange and seals thus in a simple manner in relation to the connection flange provided with a flat seal surface.

According to a beneficial embodiment of the filter system, the seal element can be formed as a shaped seal which is arranged in a circumferentially extending groove of the filter housing. The seal element can advantageously fill out the groove of the filter housing completely and thus effect a permanent and robust sealing action of the filter system in relation to the connection flange.

According to a beneficial embodiment of the filter system, the filter housing can comprise radial reinforcement ribs at its closed end. In this manner, the filter housing, which can be made of plastic material and therefore can be designed less stiff than a metal housing, can be reinforced against the fluid pressure in order to keep the shape, even at higher temperatures. In this context, fluid pressures can be beneficially limited to a maximum of 25 bars. Fluid temperatures can lie typically in the range of −40° C. to 150° C.

According to a beneficial embodiment of the filter system, the filter housing at its closed end may have a tool receptacle open outwardly in axial direction, for example, for a screwing tool. According to a further embodiment, the filter housing comprises at its closed end a tool receptacle which is open outwardly in radial direction and which facilitates fastening and releasing the filter housing. In this way, a reliable sealing action can be achieved when screwing the filter housing to the connection flange. Also, a seized filter housing can be released by means of the tool from the connection flange.

According to a beneficial embodiment of the filter system, the filter element can be arranged exchangeably about the support pipe. In this manner, the filter element can be simply exchanged by being pulled off the support pipe.

According to a beneficial embodiment of the filter system, the filter housing can be embodied of plastic material. In this context, the filter housing can be formed for example, as an injection molded plastic part. Plastic housings can be manufactured in a simple and inexpensive manner and can exhibit a great resistance in relation to environmental influences. Furthermore, plastic housings may have a minimal weight.

According to a beneficial embodiment of the filter system, the filter housing can be configured in a cone shape with a larger inner diameter facing toward the open end.

Such a shape is advantageous for removal in case of a plastics injection molding process for producing the filter housing.

In an alternative embodiment, it is also possible that the filter housing is produced as a metal housing. For example, in this context the filter housing can be configured as a die-cast part, for example, as a die-cast aluminum part. The screw thread in this case can be introduced directly into the end region of the support pipe so that no separate thread-bearing part is required. With this embodiment it is also possible to achieve beneficial manufacturing costs while providing the filter housing with a high durability.

### BRIEF DESCRIPTION OF DRAWINGS

Further advantages result from the following drawing description. In the drawings, some non-limiting embodiments of the invention are illustrated. The drawings, the description, and the claims contain numerous features in combination. A person of skill in the art will consider the features expediently also individually and combine them to meaningful further combinations.

FIG. 1 shows a longitudinal section of a filter system for a fluid, for example, oil or fuel, mounted at a connection flange, according to an embodiment.

FIG. 2 shows an isometric section view of the filter system according to FIG. 1.

FIG. 3 shows an exploded illustration of the filter system with the connection flange according to FIG. 1.

### DETAILED DESCRIPTION

In the Figures, same or same-type components are identified with same reference characters. The Figures show only examples and are not to be understood as limiting.

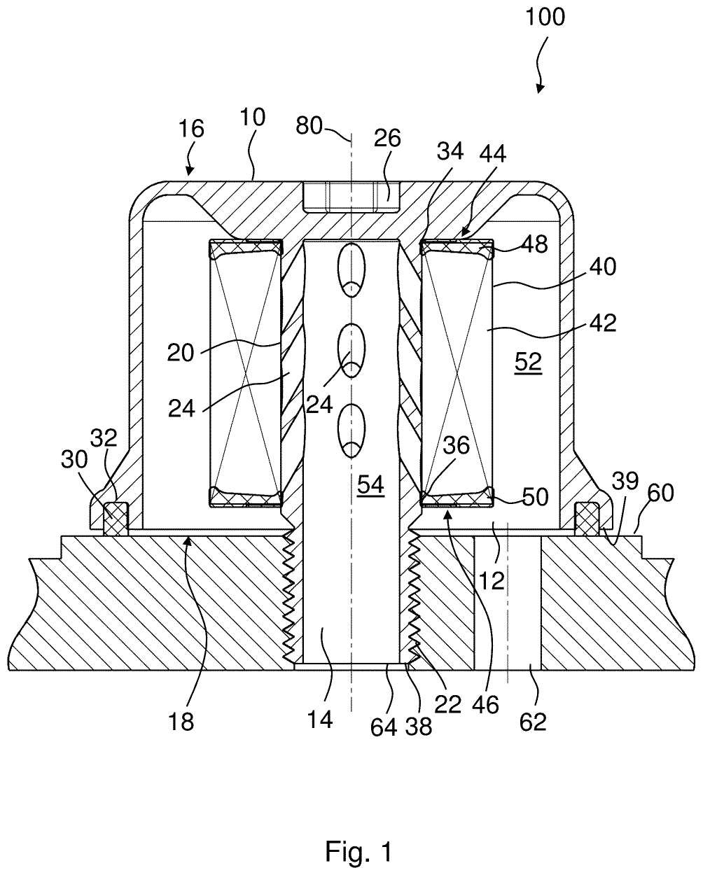

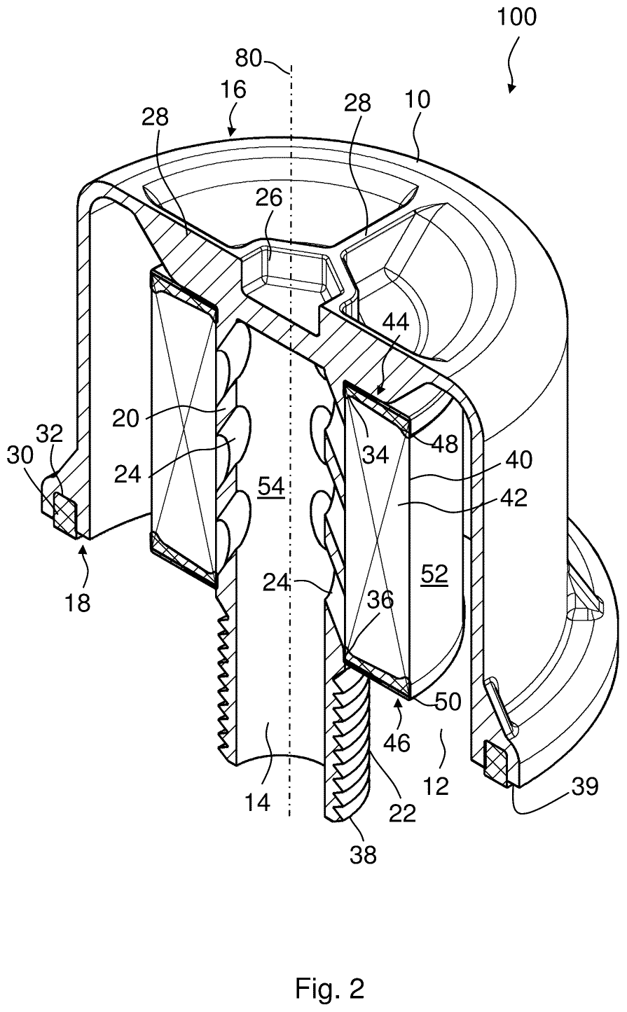

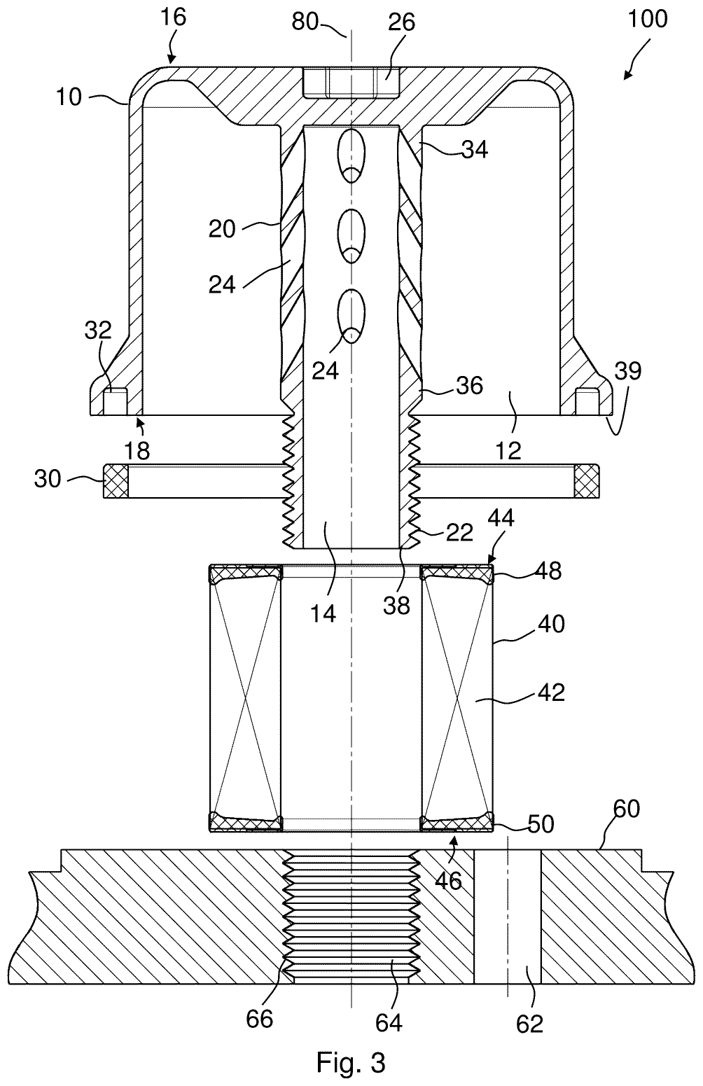

FIG. 1 shows a longitudinal section of a filter system 100 for a fluid, for example, oil or fuel, mounted at a connection flange 60 in accordance with an embodiment of the invention. FIG. 2 shows an isometric section view of the filter system 100 while in FIG. 3 an exploded illustration of the filter system 100 is illustrated.

The filter system 100 can be used, for example, as an oil or fuel filter in a combustion engine vehicle or an electrically operated vehicle.

The filter system 100 comprises a cup-shaped filter housing 10 with a support pipe 20, which is aligned along a longitudinal axis 80 and fixedly joined to the filter housing, and a filter element 40 arranged around the support pipe 20. The filter element 40 can be pushed onto the support pipe 20 and is exchangeable in this manner.

The support pipe 20 is configured as a fluid passage, for example, as a fluid outlet 14. An open end 18 of the filter housing 10 comprises also a fluid passage, for example, a fluid inlet 12, and a circumferentially extending seal element 30 arranged in a circumferentially extending groove 32.

The support pipe 20 comprises at its free end 38 facing away from the filter housing 10 a screw thread 22 for a screw connection to the connection flange 60. Furthermore, along a length extension of the support pipe 20, the support pipe 20 comprises a plurality of outlets 24 for fluid, for example, a filtered fluid. The support pipe 20 and the filter housing 10 may be formed together as one piece. The screw thread 22 must not be mandatorily configured as one piece together with the support pipe 20. For example, in case that the support pipe 20 is manufactured of plastic material, the screw thread 22 is carried by a separate component which is fixedly joined, for example, non-detachably, to the support pipe 20.

The filter element 40 comprises a filter medium body 42 which is closed at its end faces 44, 46 by end disks 48, 50. The end disks 48, 50 are configured to radially seal in relation to the support pipe 20 in this context. When the filter element 40 is mounted as intended on the support pipe 20, the end disks 48, 50 contact corresponding seal surfaces 34, 36 of the support pipe 20 and seal in this manner the filter element 40 in relation to the support pipe 20.

The filter system 100 may be screwed with the thread 22 of the support pipe 20 into a counter thread 66 of an opening 64 of the connection flange 60 which is configured as a fluid drain, for example. The circumferentially extending seal element 30 is pressed onto the connection surface of the connection flange 60 and seals in this way the filter housing 10 outwardly. In this context, the end face 39 of the filter housing 10 rests on the connection surface of the connection flange 60.

The seal element 30 is thus configured to axially seal in relation to the connection flange 60 and, for example, can be a shaped seal which is arranged in the circumferentially extending groove 32 of the filter housing 10.

The connection flange 60 comprises furthermore an opening 62 configured as a fluid inlet which, when the filter system 100 is screwed on, is in fluid communication with the fluid inlet 12 of the filter system 100. The fluid to be filtered flows through the fluid inlet 62 into the raw fluid region 52 and passes through the filter medium body 42 of the filter element 40. The filtered fluid flows through the outlets 24 of the support pipe 20 into the clean fluid region 54 in the interior of the support pipe 20 and exits then through the fluid outlet 14 into the fluid drain 64 of the connection flange 60.

The outlets 24 may extend at a slant in relation to the longitudinal axis 80 in the direction toward the open end 18 of the filter housing 10 so that the plastic housing 10, configured as one piece together with the support pipe 20, can be easily removed in an injection molding process. For this purpose, the filter housing 10 can also be configured beneficially in a cone shape with a larger inner diameter facing toward the open end 18, which represents an advantage for removal from the plastics injection molding process.

As an alternative, it is however also possible that the filter housing 10 may be embodied as metal, for example, as a die-cast part, for example, as a die-cast aluminum part.

In the isometric section view of the filter system 100 in FIG. 2, it can be seen that the filter housing 10 at its closed end 16 comprises radial reinforcement ribs 28. In this manner, the filter housing 10, which may be primarily a filter housing manufactured of plastic material, can be reinforced against a higher fluid pressure in order to keep its shape, for example, also at higher temperatures.

Also, it can be seen that the filter housing 10 at its closed end 16 comprises a tool receptacle 26, which is outwardly open in axial direction 80, for example, for a screwing tool. In this way, a reliable sealing action when screwing the filter housing 10 to the connection flange 60 can be achieved. Also, a seized filter housing 10 can be detached by means of the tool from the connection flange 60.

In the exploded illustration in FIG. 3, the sequence of assembly of the few components of the filter system 100 can be seen.

The filter housing 10 comprises the support pipe 20 which is configured as one piece together with the filter housing 10. The filter element 40 can be pushed onto the support pipe 20 in a simple manner and seals then with its end disks 48, 50 at the seal surfaces 34, 36 in relation to the support pipe 20. The shaped seal 30 is inserted into the circumferentially extending groove 32 at the open end 18 of the filter housing 10 and seals in this way in relation to the connection flange 60 when the filter system 100 is screwed to the connection flange 60 at the counter thread 66 of the opening 64.

### REFERENCE CHARACTERS

10 filter housing
12 fluid inlet
14 fluid outlet
16 closed end
18 open end
20 support pipe
22 screw thread
24 outlet
26 tool receptacle (screwing contour)
28 reinforcement rib
30 seal element
32 groove
34 seal surface
36 seal surface
38 end
39 end face
40 filter element
42 filter medium body
44 end face
46 end face
48 end disk
50 end disk
52 raw fluid region
54 clean fluid region
60 connection flange
62 fluid inlet
64 fluid drain
66 counter thread
80 longitudinal axis
100 filter system

1. A filter system for a fluid, the filter system comprising:
a filter housing having a cup shape and comprising a support pipe, wherein the support pipe is aligned along a longitudinal axis of the filter housing and fixedly joined to the filter housing;
a filter element arranged around the support pipe;
wherein the support pipe is configured as a fluid passage;
wherein the filter housing comprises a fluid passage at an open end of the filter housing and further comprises a circumferentially extending seal element configured to seal in relation to a connection flange when the filter housing is mounted as intended at the connection flange;
wherein the support pipe comprises a screw thread at an end of the support pipe facing away from the filter housing, wherein the screw thread is configured to provide a screw connection to the connection flange;
wherein the support pipe comprises, arranged along a length extension of the support pipe, at least one outlet for a fluid:
wherein the support pipe and the filter housing are formed together as one piece.

2. The filter system according to claim 1, wherein the filter element comprises a filter medium body, a first end disk arranged at a first end face of the filter medium body, and a second end disk arranged at a second end face of the filter medium body, wherein at least one of the first and second end disks is configured to radially seal in relation to the support pipe.

3. The filter system according to claim 1, wherein the at least one outlet of the support pipe extends at a slant in relation to the longitudinal axis in a direction toward the open end of the filter housing.

4. The filter system according to claim 1, wherein the circumferentially extending seal element is configured to axially seal against the connection flange.

5. The filter system according to claim 1, wherein the circumferentially extending seal element is a shaped seal arranged in a circumferentially extending groove of the filter housing.

6. The filter system according to claim 1, wherein the filter housing comprises a tool receptacle at a closed end of the filter housing, wherein the tool receptacle is open outwardly in an axial direction along the longitudinal axis.

7. The filter system according to claim 6, wherein the tool receptacle is configured to receive a screwing tool.

8. The filter system according to claim 1, wherein the filter housing comprises a tool receptacle at a closed end of the filter housing, wherein the tool receptacle is open outwardly in a radial direction in relation to the longitudinal axis.

9. The filter system according to claim 8, wherein the tool receptacle is configured to receive a spin-on filter release tool.

10. The filter system according to claim 1, wherein the filter element is arranged exchangeably around the support pipe.

11. The filter system according to claim 1, wherein the filter housing is comprised of plastic material.

12. The filter system according to claim 11, wherein the filter housing is an injection molded plastic part.

13. The filter system according to claim 11, wherein the filter housing is cone-shaped with a larger inner diameter facing toward the open end of the filter housing.

14. The filter system according to claim 11, wherein the filter housing comprises radial reinforcement ribs at a closed end of the filter housing.

15. The filter system according to claim 1, wherein the filter housing is comprised of metal.

16. The filter system according to claim 15, wherein the filter housing is a die-cast metal part.

17. The filter system according to claim 15, wherein the filter housing is a die-cast aluminum part.

18. The filter system according to claim 1, wherein the fluid passage of the support pipe is a fluid outlet and wherein the fluid passage of the filter housing is a fluid inlet.
